(19) United States
(12) Patent Application Publication
(10) Pub. No.: US 2014/0120514 A1
(43) Pub. Date: May 1, 2014

(54) Cloud Learning System Capable of Enhancing Learner's Capability Based on Then-Current Contour or Profile of Levels or Capabilities of the Learner

(71) Applicant: Cheng Hua YUAN, Taipei Hsien (TW)

(72) Inventor: Cheng Hua YUAN, Taipei Hsien (TW)

(21) Appl. No.: 13/661,043

(22) Filed: Oct. 26, 2012

(51) Int. Cl. G09B 7/00

(52) U.S. Cl. 434/362

(57) ABSTRACT

A cloud learning system capable of enhancing learner's capability based on then-current contour or profile of levels or capabilities of the learner provides tests about a subject, a skill or expertise in advance to determine then-current contour or profile of capability of the test-taker. Then learning data or material is provided to a user for training, while the learning data or material is based on the test points or formats for the test implicitly or explicitly, contained or hidden in the test questions so as to enhance some weak areas of the user detected or diagnosed in the test. The capability of the learner is enhanced and the user has higher confidence to learn the subject, the skill or the expertise further. The structure can be constructed in a cloud network structure. External content-providers can provide their teaching material to the dedicated database based on specific test points or formats.

### FIELD OF THE INVENTION

The present invention relates to network learning systems, and particularly to a cloud learning system capable of enhancing learner's capability based on then-current contour or profile of levels or capabilities of the learner.

### BACKGROUND OF THE INVENTION

Traditionally, whether it is in a physical classroom or through an on-line virtual class, a teacher needs to teach a number of students simultaneously. With such teaching scenarios the teacher has to focus on the common needs and cannot pay much attention to minute difference among individual students. In such case, the teacher is not able to help each individual student effectively, so the individual weak areas of specific learners in subjects, skills, or expertise could thus be overlooked. As a result, a learner will not be able to break through bottlenecks in his or her learning process. Moreover, from some learning process with an aim to help learners to acquire certificates of subjects, skills or expertise, such ineffective learning methodology tends to lead to failure.

Besides, with hopes to stand out and keep up with competition, more and more people are eager to learn various subjects, skills or expertise proactively. The achievement of acquiring the knowledge or mastering the know-how of these subjects, skills, or expertise is generally demonstrated as proofs or in the forms of—grades, ranking, or capability levels of the learners. Although there are many teaching or learning materials readily available or accessible by the learners, learners usually cannot make a proper distinction as what and which are suitable for them to learn, or they waste too much time looking for suitable teaching or learning material. Such disappointing process is always time and labor consuming. As a result, the enthusiasm for learning will be diminished quickly.

Nowadays, learning through Internet has become the mainstream and has gradually replaced the conventional and tangible means such as books, tapes, disks, or other physical material. There is ample of latest teaching or learning material which has been installed in some cloud environment so that the teaching or learning material about subjects, skills or expertise can be uploaded to and retrieved from websites or in forms of application programs that learners can practice and learn through various equipment or devices. Thus, learners can learn these subjects, skills or expertise through networks anytime and anywhere. Although these teaching or learning material can be graded, such graded material might not actually reflect the levels or grades of users. As normal learners are not exactly aware of their capabilities and thus it is difficult for a mechanism to provide suitable teaching or learning materials to the learners.

Therefore, there is an eager demand for a novel learning way which can provide effective learning method for learners so as to improve the defects in the conventional learning ways.

### SUMMARY OF THE INVENTION

Accordingly, the object of the present invention is to resolve the above mentioned problems in the prior arts. The present invention discloses a cloud learning system capable of enhancing learner's capability based on then-current contour or profile of levels or capabilities of the learner. In the present invention, a test about a subject, a skill or expertise is performed in advance to detect the then-current contour or profile of capability of the test-taker. Then learning data or material is provided to the user for training the user, while the learning data or material is based on the test points or formats for the test implicitly or explicitly, contained or hidden in the test questions so as to enhance some weak areas of the user detected in the test. Thus the capability of the learner is enhanced and the user has higher confidence to learn the subject, the skill or the expertise. Furthermore, the structure of the present invention can be constructed in a cloud network structure. Therefore, the external content-providers can provide their teaching material to the dedicated database of the present invention based on specific test points or formats. With the progression in learning, the teaching material can be updated. Furthermore, the learners will be interested in learning due to the quantitative assessment of the learning results.

A cloud learning system capable of enhancing learner's capability based on then-current contour or profile of levels or capabilities of the learner so that a registered user can compensate weak areas in subjects, skills or expertise, comprises a user interface, by that, a user can register into the system through a network or an application program wirelessly or by wired connectivity; an examination unit connected to the user interface for providing a function by that a user has registered to the user interface can test his (or her) capability about a subject, a skill or an expertise or performing relative actions; a test database connected to the examination unit. the test database storing the questions about various subjects, skills and expertise; the questions also provide data or material to the examination unit for testing; the questions in test database implicitly or explicitly contains specific or non-specific test points or formats for a test; the so-called test points or formats for a test mean key areas or key formats of a test hidden in a question, which served to detect the test-taker to determine whether the test-taker understand some predetermined questions in a coverage of the test or whether the test-taker has capabilities to handle specific questions about the test; a scoring system connected to the examination unit for scoring test results of the test based on the subjects, skills or expertise after examination; a learning database storing various learning data which are classified based on the items, test points or formats for the test; a learning unit connected to the learning database, the scoring system and the user interface; the learning unit providing relative learning data or material to the test-taker based on the capability contour or profile of the test-takers, test points or formats for the test and the contour or profile level of the capabilities from the test so as to boost the contour or profile level or capabilities of the test-taker; wherein the user firstly takes test of the subjects, the skills or the expertise; then the learning unit provides relative training data or material from the learning database to the user based on a level or capability from analyzing the test so as to train the user, especially, the learning system aims to compensate weak areas from analyzing the testing points and the types for the test in the test.

The learning unit has a test points and type for the test analyzer for finding relative data or material about test points or formats for the test from the test result about the subjects, skills or expertise.

The various objects and advantages of the present invention will be more readily understood from the following detailed description when read in conjunction with the appended drawing.

### BRIEF DESCRIPTION OF THE GRAPHS

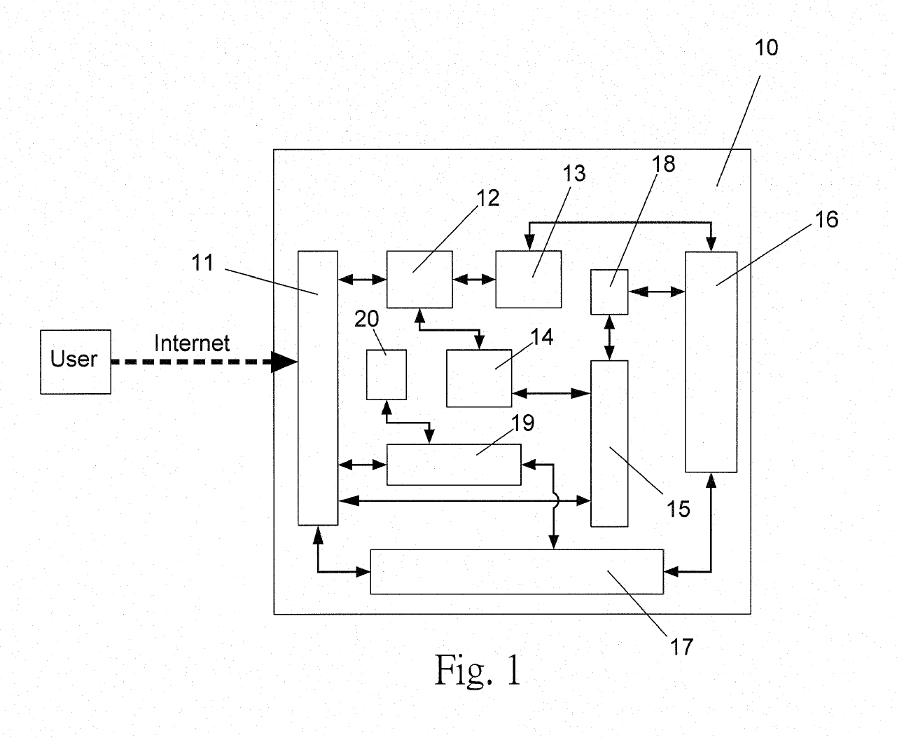

FIG. 1 is a block diagram about the first embodiment of the present invention.

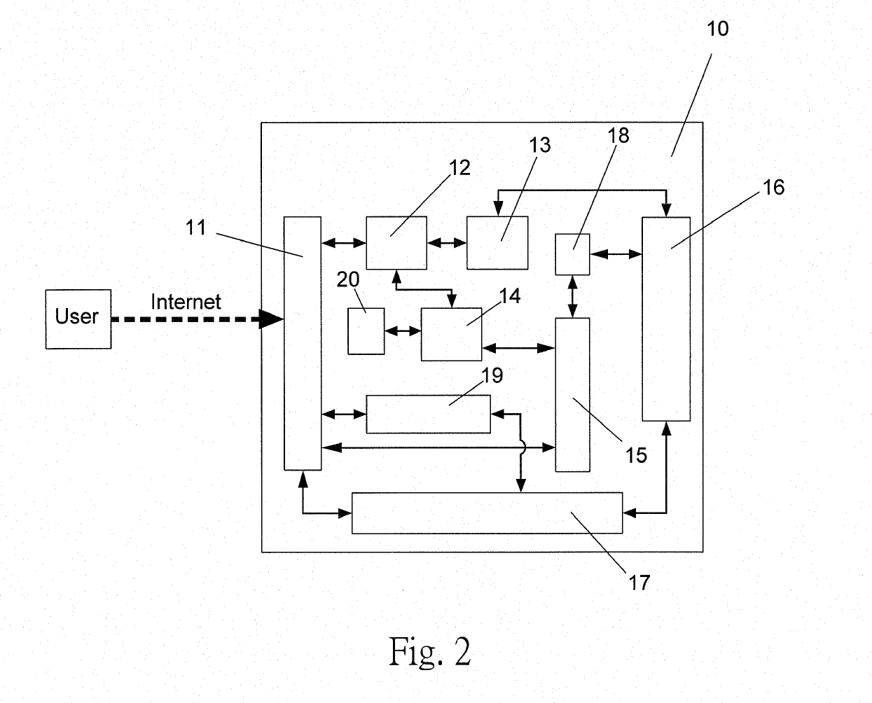

FIG. 2 is a block diagram showing another connection way for the certification and differentiating unit of the present invention.

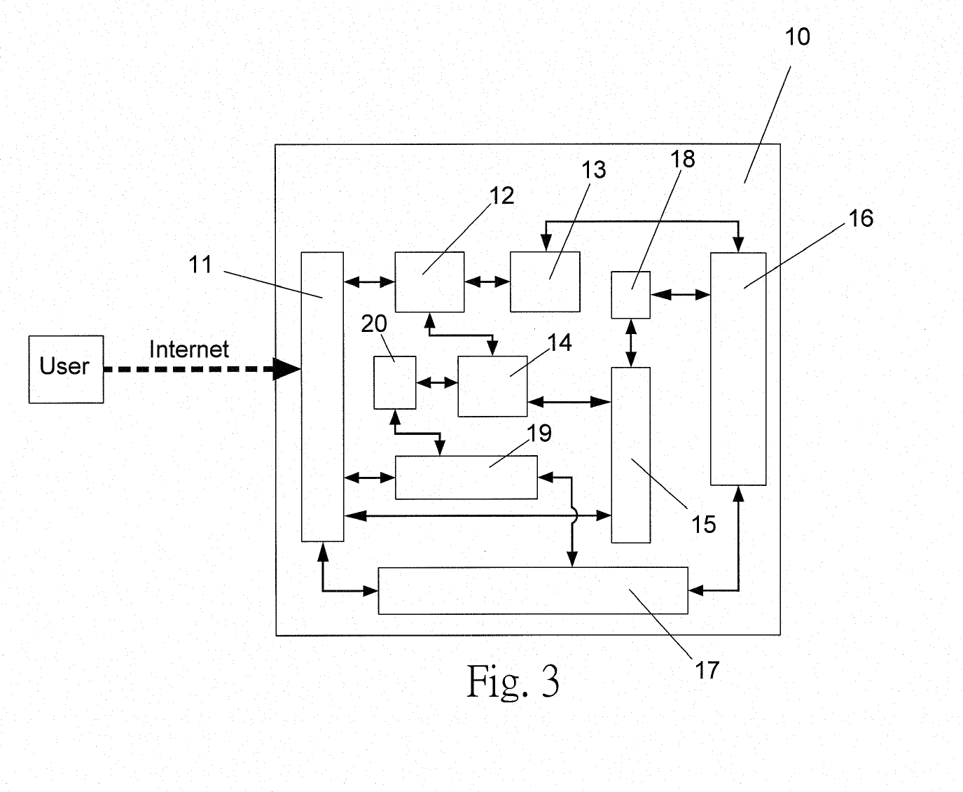

FIG. 3 is a block diagram showing that the certification and differentiating unit can be both connected to a history recording unit and a scoring system.

### DETAILED DESCRIPTION OF THE PREFERRED EMBODIMENTS

In order that those skilled in the art can be understood through further present invention, a description will be described in the following in details. However, these descriptions and the appended graphs are only used to cause those skilled in the art to understand the objects, features, and characteristics of the present invention, but not to be used to confine the scope and spirit of the present invention defined in the appended claims.

In the cloud learning system capable of enhancing learner's capability based on then-current contour or profile of levels or capabilities of the learner of the present invention, a user makes test in advance so the contour or profile of the test-taker's current level, quality or capability of the user in some specific subjects, skills or expertise can be diagnosed and indentified. Then the system analyzes the levels and grades based on the test points and types for the tests for providing some suitable teaching or learning materials to the test-takers so as to enhance the weak areas of the user. The teaching or learning materials provided to users are individual-specific, based on the detected weak areas and strength of the test-takers.

In the present invention, the structure of the present invention will be described with reference to the attached graphs. The cloud learning system 10 capable of enhancing learner's capability based on then-current contour or profile of levels or capabilities of the learner of the present invention comprising the following elements.

A user interface 11 serves as an interface between users and a cloud learning system 10 of the present invention so that a user can register into the system through a network wirelessly or by wired connectivity.

An examination unit 12 is connected to the user interface 1. The examination unit 12 includes at least examining item about a subject, a skill, or expertise (such as tests of vocabularies, phrases, grammars, reading, listening comprehension, speaking, writing etc. in English subject). The examination unit 12 provides the function by that a user registered to the user interface 11 can test his (or her) capability about the subjects, skills or expertise or performing relative actions.

A test database 13 is connected to the examination unit 12. The test database 13 stores the questions about various subjects, skills and expertise. The questions also provide data or material to the examination unit 12 for testing.

The questions in test database 13 implicitly or explicitly contain or is hidden with some specific or non-specific test points or formats for the test. The so-called test points or formats for the key areas or key formats of a test hidden in a question, which serve to detect the level, grade or quality of the test-taker for determining whether the test-taker understand some predetermined questions in a coverage of the test or whether the user has capabilities to handle specific questions within the coverage of the test.

A scoring system 14 is connected to the examination unit 12 for scoring test results of the test based on the subjects, skills or expertise after examination. The scoring results are transferred to a succeeding unit. The scoring system 14 can analyze the comprehension or capabilities of the test-taker about the test points or formats for tests. The scoring results are recorded based on the user identification numbers or other ways to identify the users (such as passwords or any other ways of identifications) of the test-takers.

A learning database 18 stores various learning data or material which are classified and graded based on the items, test points or formats for the test.

A learning unit 15 is connected to the learning database 18, the scoring system 14 and the user interface 11. The learning unit 15 has a test points and type for the test analyzer 151 for finding relative data or material about test points or formats for the test from the test result about the subjects, skills or expertise and then the learning unit 15 find learning data in the learning database 18 and the learning data is transferred to the user interface 11 to train the user. The learning unit 15 provides relative learning data to the test-taker based on the then-current capability contour or profile of the test-takers, test points or formats for the test and the level of the capabilities from the test so as to boost the level or capabilities of the test-taker.

A history recording unit 19 is connected to the user interface 11 for recording the registering data from the test-taker, kinds of tests and items, test results, scoring, test points and types for the test. These data are recorded as history data based on the capability contour or profile of test-takers. The data can be presented as graphs or tables so that the test-taker can effectively perceive the learning results. Furthermore, analysis reports are provided to test-takers so that the test-taker can precisely understand the leaning effects. Thus, the test-taker can fully be aware of areas necessary to be further enhanced.

A certification and differentiating unit 20 is connected to the history recording unit 19. The certification and differentiating unit 20 serves to set the required conditions and criteria for examination, certification and differentiation. The data for a test-taker is inputted from the history recording unit 19 to the certification and differentiating unit 20 so as to determine the level or grade of the test-taker for specific subjects, skills or expertise. The certification and differentiating unit 20 can award relative proofs, such as certificates or licenses

With reference to FIG. 2, another connection for the certification and differentiating unit 20 is illustrated. The certification and differentiating unit 20 is further connected to the scoring system 14. The scoring results from the scoring system 14 are as a base for certification and differentiating. Thus, the processes of certification and differentiating can be preformed directly in the certification and differentiating unit 20 after testing without the data from the history recording unit 19. Referring to FIG. 3, it is illustrated that certification and differentiating unit 20 is directly connected to the history recording unit 19 and the scoring system 14. Thus the bases for certification and differentiating can be based on the data from the scoring system 14 or the data from the history recording unit 19.

An external content-provider registration interface 16 is connected to the test database 13 and the learning unit 15. The external content-provider registration interface 16 causes that an external content-provider can register to the system of the present invention wirelessly or by wired way so as to add data to or amended data in the test database 13 and the learning database 18 based on the test points or formats for the test.

A charging and paying interface 17 is connected to the history recording unit 19, the external content-provider registration interface 16 and the user interface 11. The charging interface 17 serves to charge and pay to the users or the external content-providers based on the actions of the users or the external content-providers, or based on the learning history recorded in the history recording unit 19, for example, to charge and pay to a user based on the detected level of the vocabulary capability of a user after learning process of the present invention completed.

In the following, an application of the present invention is described. A language learning subject is used as an example, but it is not used to confine the scope of the present invention, while the present invention is suitable for various subjects, skills or expertise.

By above mentioned structure of the present invention, a test-taker make tests about various areas in language learning, such as tests of vocabularies, phrases, grammars, reading, listening comprehension, speaking, writing etc. in English subject. The test items implicitly or explicitly, contain or are hidden with different test points and types for the test (such as the verb tenses in grammar test.) After the test, the learning unit analyzes the contour or profile of levels and grades of the test-takers and thus provides suitable teaching or learning materials to the test-taker based on the analysis. For example, if the test-taker has lower scores in listening comprehension, the learning unit will provide teaching or learning comprehension material suitable for the specific weak areas of listening comprehension capability to the user and suggests the test-taker to take much time to train his (or her) listening comprehension capability. As a result, the weak areas of the test-taker's listening comprehension can be enhanced.

Therefore, the capability of a user can be enhanced based on the detected contour or profile of level or the capability of the user. The external content-providers can update the teaching or learning material in the test database 13 based on the latest development of language teaching techniques. The website or learning system manager can charge and pay the external content-providers based on the actions in the external content-provider registration interface 16 and the user interface 11.

The structure of the present invention can be applied to a network structure. The users could learn through webpage or other application program. The external content-providers can update or add relative data based on sets of predefined rules or specific requirements. A user can register to the user interface 11 through a network connection or an application program. Then, examination unit 12 provides tests of subjects, skills or expertise to the users. Then the scoring system 14 scores the test results about the subjects, skills or expertise to cause the user to understand the learning material or gain the capability about the coverage of the test. Then the learning unit 15 finds some training data to train the user, wherein the training data is based on the test points or formats for the test implicitly hidden in the test questions

It should be noted that the units of the present invention can be distributed in one or a plurality of servers.

Advantages of the present invention are that a test about a subject, a skill or expertise is performed in advance to detect the contour or profile of capability of the test-taker. Then learning data is provided to a user for training the user, while the learning data is based on the test points or formats for the test implicitly hidden in the test questions so as to enhance some weak areas of the user detected or diagnosed by the test. Thus the capability of the learner is boosted and the user has higher interest to learn the subject, the skill or the expertise. Furthermore, the structure of the present invention can be constructed in a cloud network structure. Therefore, the external content-providers can provide their teaching or learning material to the dedicate database of the present invention based on specific test points or formats. With the progression in learning, the teaching or learning material can be updated. Furthermore, the learner feels interested in learning due to the quantifiable data of the learning result.

The present invention is thus described, it will be obvious that the same methodology may be adapted by or varied in many other ways. Such variations are not to be regarded as a departure from the spirit and scope of the present invention, and all such modifications as would be obvious to one skilled in the art are intended to be included within the scope of the following claims.

What is claimed is:

1. A cloud learning system capable of enhancing learner's capability based on then-current contour or profiles of levels or capabilities of the learner so that a registered user can compensate weak areas in subjects, skills or expertise, comprising:
a user interface, by that, a user can register into the system through a network or an application program wirelessly or by wired connection;
an examination unit connected to the user interface for providing a function by that a user has registered to the user interface can test his (or her) capability about a subject, a skill or a expertise or performing relative actions;
a test database connected to the examination unit. the test database storing the questions about various subjects, skills and expertise; the questions also provide data to the examination unit for testing;
the questions in test database implicitly or explicitly, contain specific or non-specific test points or formats for a test; the so-called test points or formats for a test mean key areas or key formats of a test hidden in a question, which served to detect whether the test-taker understand some predetermined questions in a coverage of the test or whether the user has capabilities to handle specific questions on the test;
a scoring system connected to the examination unit for scoring test results of the test based on the subjects, skills or expertise after examination;
a learning database storing various learning data which are classified based on the items, test points or formats for the test;
a learning unit connected to the learning database, the scoring system and the user interface; the learning unit providing relative learning data to the test-taker based on the categories of the test-takers, test points or formats for the test and the level of the capabilities from the test so as to boost the level or capabilities of the test-taker;
wherein the user firstly makes test to the subjects, the skills or the expertise; then the learning unit provides relative training data from the learning database to the user based on a level or capability from analyzing the test so as to train the user, especially, the learning system aims to compensate weak areas from analyzing the testing points and the types for the test in the test.

2. The cloud learning system as claimed in claim 1, wherein the learning unit has a test points and type for the test analyzer for finding relative data about test points or formats for the test from the test result about the subjects, skills or expertise.

3. The cloud learning system as claimed in claim 1, wherein the learning unit includes a test system for at least one subjects, skills or a expertise.

4. The cloud learning system as claimed in claim 1, further comprising:
an external content-provider registration interface connected to the test database and the learning unit; an external content-provider can register through the external provider registration interface to the learning system so as to add data to or amended data in the test database and the learning database based on the test points or formats for the test.

5. The cloud learning system as claimed in claim 1, wherein the external content-provider registers to the learning system wirelessly or by wired way.

6. The cloud learning system as claimed in claim 3, further comprising:
a history recording unit connected to the user interface for recording the registering data from the test-taker, kinds of tests and items, test results, scoring, test points and types for the test; these data being recorded as history data based on the contour or profile of the user so as to provide to the user to cause that the test-taker can precisely understand the leaning effects.

7. The cloud learning system as claimed in claim 5, further comprising:
a charging and paying interface connected to the history recording unit, the external content-provider registration interface and the user interface; the charging and paying interface charging and paying the users or the external content-providers based on actions of the users or the external content-providers, or based on the learning history recorded in the history recording unit.

8. The cloud learning system as claimed in claim 6, further comprising:
a certification and differentiating unit connected to the history recording unit; the certification and differentiating unit setting required conditions and criteria for examination, certification and differentiation; the data for a user being inputted from the history recording unit to the certification and differentiating unit so as to determine a level or a grade of the user for specific subjects, skills or expertise; the certification and differentiating unit awards relative proofs.

9. The cloud learning system as claimed in claim 6, further comprising:
a certification and differentiating unit further connected to the scoring system; the certification and differentiating unit setting required conditions and grades for examination, certification and differentiation; the scoring result from the scoring system being used as a base for certification; and
also used to differentiate the ranks or grades about the subjects, skills and expertise as a qualification for certification.

10. The cloud learning system as claimed in claim 7, further comprising:
a certification and differentiating unit further connected to the scoring system; the scoring result from the scoring system is used as a base for certification; and also used to differentiate the grades about the subjects, skills and expertise as a qualification for certification.

11. The cloud learning system as claimed in claim 1, wherein the elements of the system is distributed in one or a plurality of servers.
